(19) United States
(12) Patent Application Publication
(10) Pub. No.: US 2015/0059230 A1
(43) Pub. Date: Mar. 5, 2015

(54) Universal Fishing Rod Holder

(71) Applicants: Jerome Ennis, Beaumont, TX (US); Trent Warren, Austin, TX (US)

(72) Inventors: Jerome Ennis, Beaumont, TX (US); Trent Warren, Austin, TX (US)

(21) Appl. No.: 14/469,581

(22) Filed: Aug. 27, 2014

Related U.S. Application Data
(60) Provisional application No. 61/871,041, filed on Aug. 28, 2013.

(51) Int. Cl. A01K 97/10; A01K 97/00; A01K 99/00

(52) U.S. Cl. CPC A01K 97/10; A01K 99/00; A01K 97/00
USPC 43/4.5; 43/21.2

(57) ABSTRACT

The present invention relates generally to an improved mechanism to hold fishing rods in place. The invention allows a fisherman to secure a fishing rod to secondary objects of multiple shapes.

### PRIORITY

This application claims priority to U.S. Provisional Patent Application No. 61/871,041 entitled “Universal Fishing Rod Holder” by Jerome Ennis filed on Aug. 28, 2013. That application is incorporated by reference in its entirety.

### BACKGROUND

A frequent issue encountered by fishermen using fishing rods is that they may have to wait extended times for fish to be caught on a hook. Tending to a fishing rod prevents fishermen from engaging in other activities. Conversely, fishermen do not want to release their fishing rod for fear that a fish will be caught on the hook while the fishing rod is not secured and risk losing the fishing rod. A strategy used by some fishermen involves securing a fishing rod to a secondary object and retrieving the fishing rod when they see signs of a fish on the hook. Some fishermen even take the step of deploying multiple fishing rods secured to secondary objects to increase the chances of catching a fish.

Locations where fishermen frequent typically have some form of barrier between the fishermen and the water for safety reasons. These range from barriers made of hurricane fencing, to wooden barriers, to solid walls with a railing. Equivalent structures may be found on boats used by fisherman. There is no limit to what form these barriers may take.

Fishermen have tried to find ways to bind their fishing rods to secondary objects, such as the aforementioned barriers, with limited success. Fishermen need to keep the fishing rod secured, but also them to be released for operations as needed. Previous devices have been limited to use with a specifically shaped structure, such as safety bar, but have not allowed for the versatility needed to couple to secondary objects of various shapes. Since the structures at each fishing location vary from place to place, there is a need for a universal holder that can be used in a multitude of locations.

### SUMMARY

Pursuant to the forgoing background of the invention, the disclosed invention allows a fisherman to secure his fishing rod to a secondary object 200 for the purpose of immobilizing the fishing rod. The disclosed invention, hereafter the holder 100, comprises a receptacle 120 capable of receiving the fishing rod and fastener straps 140 used to secure the receptacle 120 to the secondary object 200. The fastener straps 140 comprise a male fastener surface 144 and/or a female fastener surface 146 that allow multiple configurations to secure the holder 100 to the secondary object 200.

### FIGURES

FIG. 1 is a generic view of the holder.

FIGS. 2A-2D show various exemplary embodiments of the invention with different configurations of the fastener straps 140.

FIGS. 3A-C show how the holder may be coupled to secondary objects 200 of different shapes.

FIG. 4A-B shows different attachments that may be coupled to the ventral end 124 of the holder 100.

FIG. 5A-B shows how an attachment such as a drink holder 182 may be coupled to the side of the holder 100.

### DETAILED DESCRIPTION

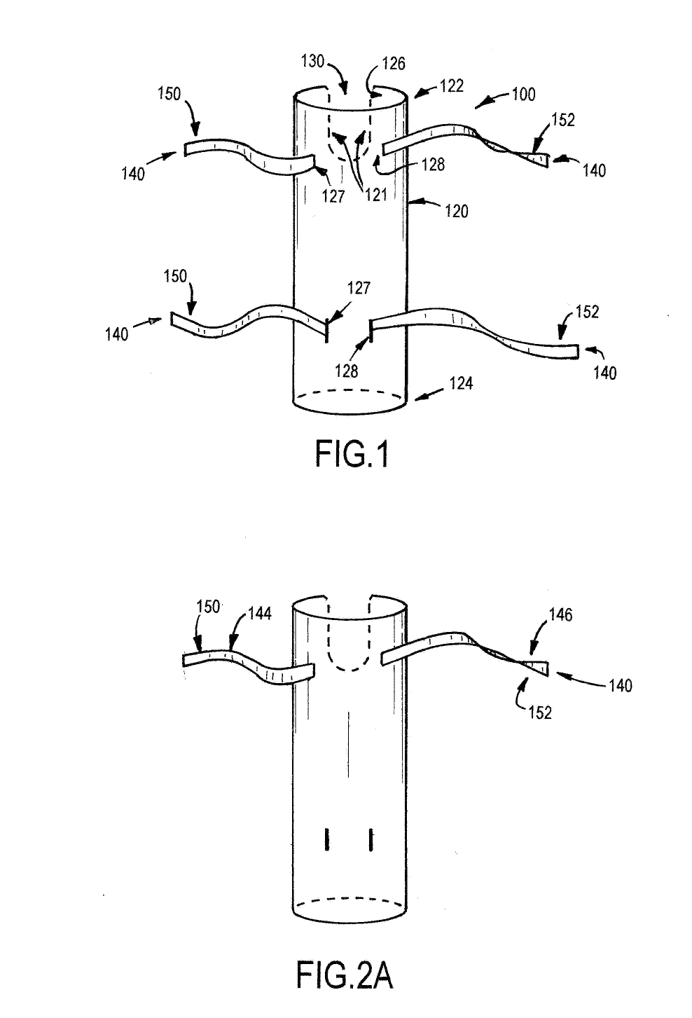

The exemplary embodiment of the holder 100 shown in FIG. 1 comprises a receptacle 120 and at least one fastener strap 140. The receptacle 120 is generally cylindrical in shape with at least one aperture 130 at the dorsal end 122 to accept a fishing rod. The ventral end 124 is closed in the exemplary embodiment. In an alternate exemplary embodiment, the ventral end 124 may contain a second aperture 130, allowing the fishing rod to pass outside the receptacle 120 or allow the fishing rod to enter from either end of the receptacle 120. The receptacle 120 may have any cross section size and shape, as long as it can accept the fishing rod. The fishing rod is slideably receivable into the receptacle 120.

In another exemplary embodiment, the interior surface 126 of the receptacle 120 may comprise a material that increases the coefficient of friction between the receptacle 120 and the fishing rod, preventing accidental fishing rod release while allowing rapid withdrawal of the fishing rod by the fisherman. In another exemplary embodiment, the receptacle 120 may include a fastening mechanism that locks the fishing rod into the receptacle 120 until the fisherman unlocks the fishing rod from the holder 100. In an alternate exemplary embodiment, the fishing pole may be inserted so far into the receptacle 120 that when a fish caches on the line of the fishing pole, the force of the fish pulling on the line will apply pressure in a matter that is perpendicular to the position of the pole in the receptacle 120, keeping the pole in place until a fisherman retrieves the fishing pole form the holder 100.

In an exemplary embodiment, the operation of the holder 100 involves at least one fastener strap 140 encircling an element of a secondary object 200, binding the holder 100 to the secondary object 200. The fastener straps 140 are designed to allow multiple configurations of mounting the holder 100 to a secondary object 200. The fastener straps 140 may comprise one of hook & loop fasteners, snap fasteners, button fasteners, adhesive fasteners, or any other fastener type that allows coupling by the fastener straps 140 making contact with each other. This allows the fastener straps 140 to be fastened in multiple configurations along multiple parts of the fastener strap 140. The fastener straps 140 allow for the holder 100 to be secured to both small and large secondary objects 200 with equivalent levels of support.

Fastener straps 140 may contain at least one of either a male fastener surface 144 or a female fastener surface 146. In the exemplary embodiment, each holder 100 has at least one fastener strap 140. Regardless of the configuration of fastener straps 140, each holder 100 has at least one male fastener surface 144 and one female fastener surface 146 among the fastener straps 140. Any other equivalent fastening mechanisms are within the scope of this disclosure. This combination of male fastener surfaces 144 and female fastener surfaces 146 allows fastener straps 140 them to be coupled in multiple configurations, which allow the holder 100 to be coupled to secondary objects 200 of various shapes. In an exemplary embodiment, this occurs by placing in the holder 100 adjacent to the secondary object 200, having the fastener straps 140 encircle an element of the secondary object 200, tightening the fastener straps 140 in such a manner that the holder 100 remains in contact with the secondary object 200, and then coupling the fastener straps 140 together for the holder 100 to maintain position relative to the secondary object 200.

In the exemplary embodiment, fastener straps 140 enter the receptacle 120 through a first slit 127 in the side of the receptacle 120 and exit from a second slit 128 in the side of the receptacle 120. Embodiments may comprise one fastener strap 140 or multiple fastener straps 140 as needed. In the exemplary embodiments, the fastener straps 140 have a first end 150 and a second end 152, both of which comprise a male fastener surface 144 and/or a female fastener surface 146 depending on the specific embodiment.

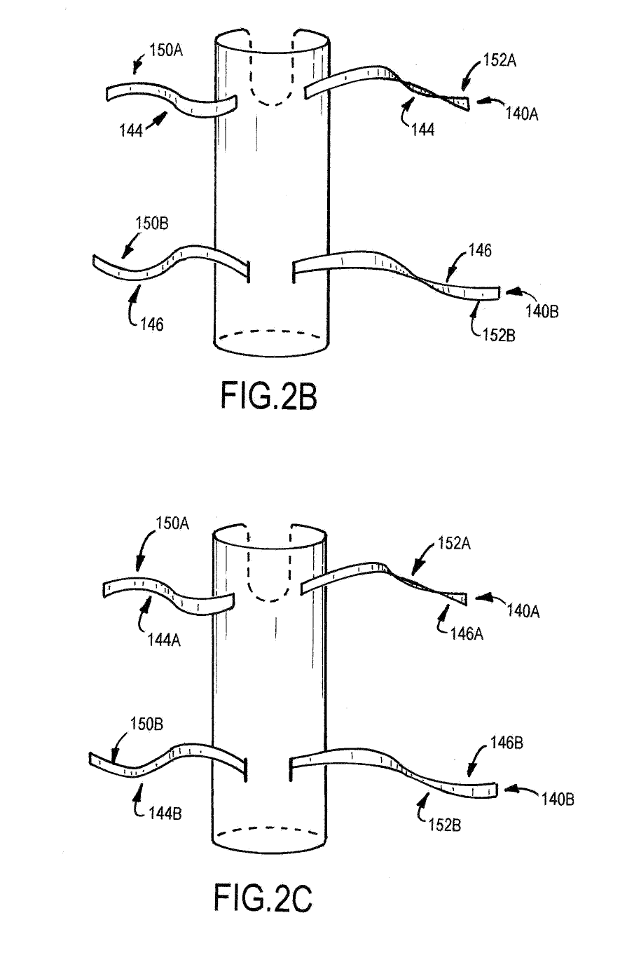

FIGS. 2A-D show four different alternative exemplary embodiments. These are shown for illustrative purposes only and are in no way limiting. These figures will involve fastener straps 140A, B with first ends 150 and second ends 152, and with male fastener surfaces 144 and female fastener surfaces 146 in different configurations.

FIG. 2A shows an embodiment with a single fastener strap 140. The first end 150 of the fastener strap 140 is comprises a male fastener surface 144 and the second end 152 comprises a female fastener surface 146. In this embodiment, the male fastener surface 144 that may couple to the female fastener surface 146 once the fastener straps 140 encircle the secondary object 200. In operations, the holder 100 adjacent to the secondary object 200, having the fastener straps 140 encircle an element of the secondary object 200, tightening the fastener straps 140 in such a manner that the holder 100 remains in contact with the secondary object 200, and then coupling the fastener straps 140 together for the holder 100 to maintain position relative to the secondary object 200.

FIG. 2B shows an embodiment where there are two separate fastener straps 140A, B. The first fastener strap 140A comprises a first end 150A and second end 152A with male fastener surfaces 144. The second fastener strap 140B comprises a first end 150B and second end 152B with female fastener surfaces 146. In this embodiment, the first end 150A may couple to second first end 150B or second end 152B. The second end 152A may couple to first end 150B or second end 152B. In this embodiment, the male fastener surfaces 144 of the first fastener strap 140A may couple to the female fastener surfaces 146 of the second fastener strap 140B. In operations, the holder 100 adjacent to the secondary object 200, having the fastener straps 140 encircle an element of the secondary object 200, tightening the fastener straps 140 in such a manner that the holder 100 remains in contact with the secondary object 200, and then coupling the fastener straps 140 together for the holder 100 to maintain position relative to the secondary object 200.

FIG. 2C shows an embodiment where there are two separate fastener straps 140A, B. The first fastener strap 140A comprises a first end 150A made of male fastener surfaces 144A and second end 152A with of female fastener surfaces 146A. The second fastener strap 140B comprises a first end 150B with of male fastener surfaces 144B and second end 152B with female fastener surfaces 146B. In this embodiment, the first end 150A may couple to second end 152A or to second end 152B. The second end 152A may couple to first end 150A or first end 150B. In this embodiment, the male fastener surfaces 144 may couple to the female fastener surfaces 146. In operations, the holder 100 adjacent to the secondary object 200, having the fastener straps 140 encircle an element of the secondary object 200, tightening the fastener straps 140 in such a manner that the holder 100 remains in contact with the secondary object 200, and then coupling the fastener straps 140 together for the holder 100 to maintain position relative to the secondary object 200.

FIG. 2D shows an embodiment where there are two separate fastener straps 140A, B. The first fastener strap 140A comprises a first end 150A with of male fastener surfaces 144A on one side with a female fastener surface 146A on the opposite side, and second end 152A with a male fastener surface 144A′ on one side with a female fastener surfaces 146A′ on the opposite side. The second fastener strap 140B comprises a first end 150B made of male fastener surfaces 144B on one side with a female fastener surface 146B on the opposite side, and second end 152B with a male fastener surface 144B′ on one side with a female fastener surfaces 146B′ on the opposite side. In this embodiment, the first end 150A may couple to first end 150A, second end 152A, first end 150B, or to second end 152B based on the orientation of the male fastener surface 144, 144′ and female fastener surface 146, 146′. In this embodiment, the second end 152A may couple to first end 150A, second end 152A, first end 150B, or to second end 152B based on the orientation of the male fastener surface 144, 144′ and female fastener surface 146, 146′. In this embodiment, the first end 150B may couple to first end 150A, second end 152A, first end 150B, or to second end 152B based on the orientation of the male fastener surface 144, 144′ and female fastener surface 146, 146′. In this embodiment, the second end 152B may couple to first end 150A, second end 152A, first end 150B, or to second end 152B based on the orientation of the male fastener surface 144, 144′ and female fastener surface 146, 146′. In operations, the holder 100 adjacent to the secondary object 200, having the fastener straps 140 encircle an element of the secondary object 200, tightening the fastener straps 140 in such a manner that the holder 100 remains in contact with the secondary object 200, and then coupling the fastener straps 140 together for the holder 100 to maintain position relative to the secondary object 200. This embodiment has the additional advantage on each end of the fastener strap 140 being able to couple to itself due to each side having a male fastener surface 144 and a female fastener surface 146.

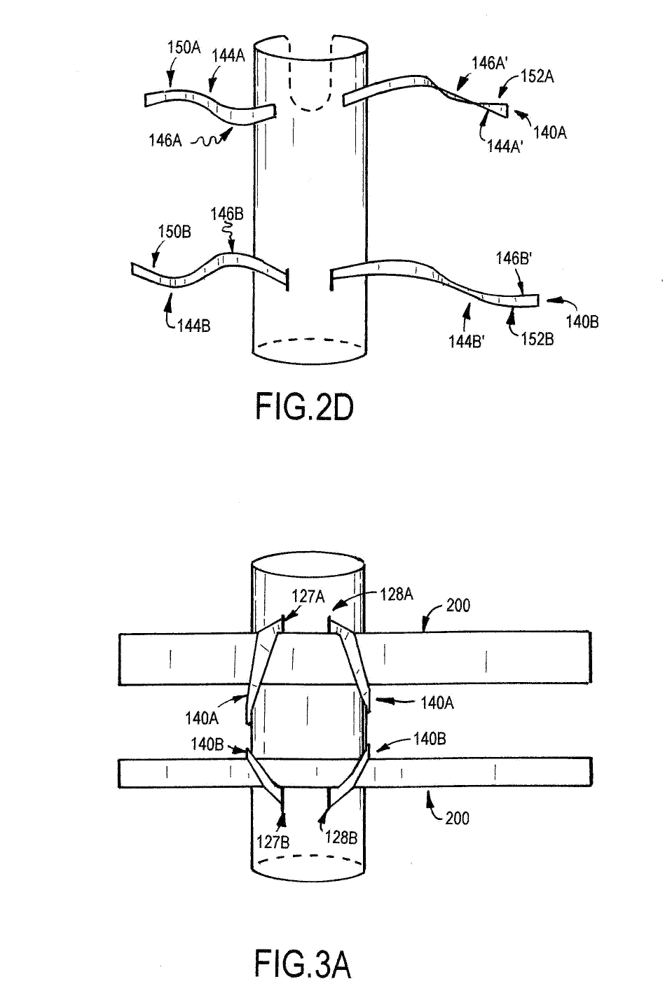

FIG. 3A shows how the fastener straps 140A, B would look when engaged in an exemplary embodiment when fastened to a secondary object 200. The view shown is from the opposite side of the secondary object 200. The first fastener strap 140A and second fastener strap 140B extends from the first slit 127A, B and second slit 128A, B, wrap around a secondary object 200, and then couple together, securing the holder 100 in place.

FIGS. 3B and 3C illustrate how the holder 100 can adapt to any structure, regardless of the shape of the secondary object 200. These examples show how the holder 100 can attach to cylindrical secondary objects 220 or rectangular secondary objects 210 using the same process as shown in FIG. 3A. The first fastener strap 140A and the second fastener strap 140B extend from the first slit 127A, B and second slit 128A, B for each fastener strap 140, encircle the secondary objects 210, 220, and reconnect on the opposite side. However, the holder 100 is not limited to these shapes.

Multiple disclosed embodiments are capable of attaching to secondary objects 200 of various shapes. One example would be cylindrical safety railing made of horizontal cylinders, which is common in areas where fishing is allowed. The holder 100 maybe placed next to the railing while the fastener straps 140 are oriented and coupled in a manner to secure the holder 100 to the safety railing as discussed in previous embodiments. The configuration of the fastener straps 140 allows the holder 100 to be coupled to the secondary object 200 as depicted in accordance with what was previously described in FIGS. 2A-D and 3A-C.

Another configuration of cylindrical railing that the holder 100 may couple to consists of horizontal and vertical elements. In such a configuration, the holder 100 may be placed adjacent to said secondary object 200 and the fastener straps 140 may be coupled accordingly. The configuration of the fastener straps 140 allows the holder 100 to be coupled to the secondary object 200 as depicted in accordance with what was previously described in FIGS. 2A-D and 3A-C.

Another exemplary embodiment allows the holder 100 may be coupled to a structure that is exclusively horizontal or exclusively vertical. Unlike previous configurations, this embodiment would keep the holder 100 in position by making the holder 100 secured against the secondary object 200 to keep it in position. The configuration of the fastener straps 140 allows the holder 100 to be coupled to the secondary object 200 as depicted in accordance with what was previously described in FIGS. 2A-D and 3A-C.

Another secondary object 200 that the holder 100 may be coupled to is a railing with an irregular shape, such as a highway safety railing. Unlike the safety railing previously discussed, the holder 100 would not be placed flush against the railing, but would only with a part of the railing due to the shape of the highway safety railing. As with the previously disclosed embodiments, the fastener straps 140 would encircle the safety railing and be oriented and coupled to secure the holder 100 to the highway safety railing. Other irregular surfaces that the holder 100 may be coupled to include, but are not limited to, tires, chairs, and bicycles. The configuration of the fastener straps 140 allows the holder 100 to be coupled to the secondary object 200 as depicted in accordance with what was previously described in FIGS. 2A-D.

In the previously described embodiments, the fastener straps 140 pass through the interior of the receptacle 120. In an alternative embodiment, the fastener straps 140 may be coupled exclusively to the exterior of the receptacle 120 by any means know to those skilled in the art. In such a configuration, there could be a fastener strap 140 similar to those that were used in the previously disclosed embodiments, except for the external connection to the receptacle 120. In another embodiment, the fastener straps 140 may have a proximal end coupled to the receptacle 120 and a distal end extending away from the receptacle 120. The distal ends of two or more fastener strap 140 would function in sustainably the same manner as the previously described fastener straps 140 which can be manipulated to bind the holder 100 to a secondary object 200. This configuration still allows for at least one male fastener surface 144 and at least one female fastener surface 146 between the attached fastener straps 140.

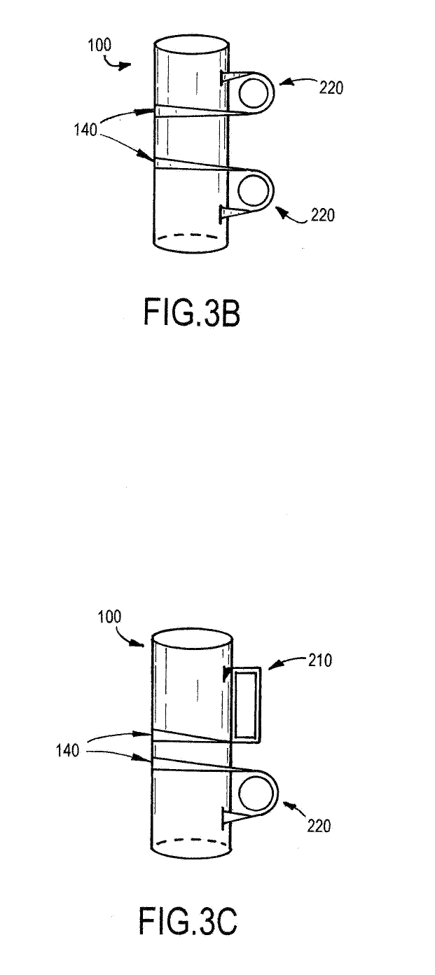

FIG. 4A-B shows an addition to the holder 100 where the ventral end 124 of the receptacle 120 may be constructed to receive additional tools. These tools may fasten to the receptacle 120 in any way know to those skilled in the art. In an exemplary embodiment, a twist on cap 170 is used to couple to tools to the receptacle. Examples of such additions could include a hook 172 for leaders, nets, etc. Another example is a flashlight 174 allowing an emergency light if needed. Another example includes a bottle opener 176 for use while in the field.

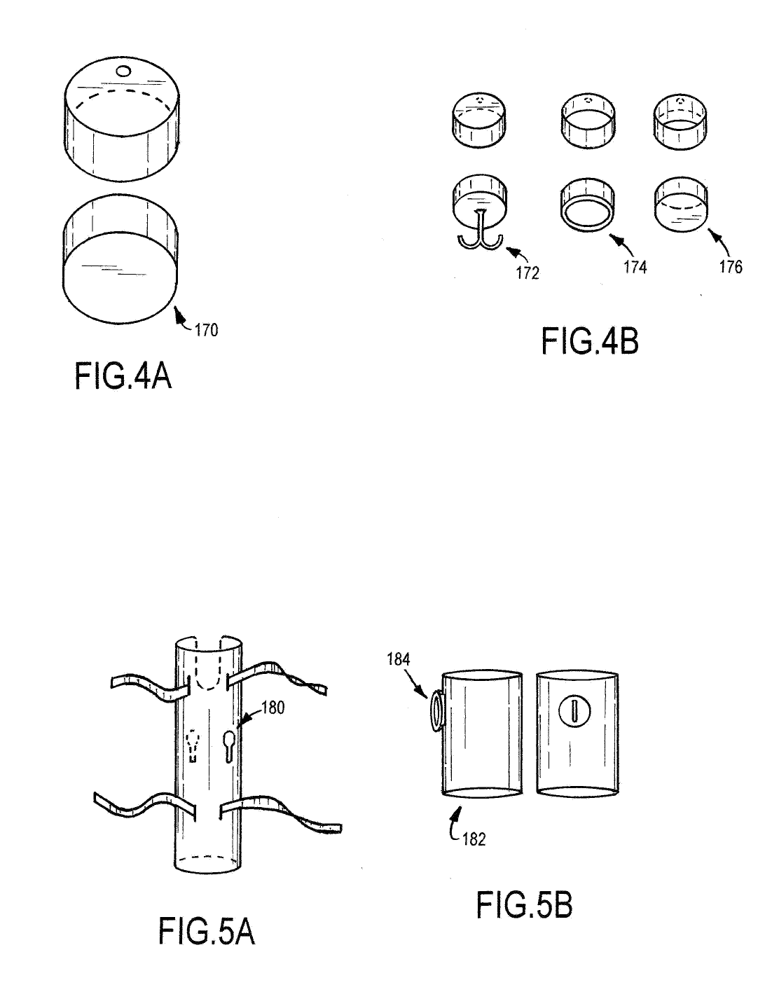

In a further embodiment shown in FIGS. 5A-B, the key hole 180 on the side of the holder 100 may be used to couple an item to the holder 100, such as a drink holder 182 with a projection 184 designed to interface with the key hole 180. Other small tools may be incorporated without departing from the scope of this invention.

In a further embodiment, the receptacle 120 may further comprise a notch 121 in the side of the receptacle 120 adjacent to the dorsal end 122 of the receptacle 120, which comprises the aperture 130. The notch 121 may be dimensioned to accommodate the reel when the fishing rod is inserted.

In another exemplary embodiment, the receptacle 120 may be capable of telescopic extension, allowing the receptacle 120 to become longer or shorter as needed. A further advantage of the telescopic feature would be portability and the ability to accommodate fishing poles of various lengths.

In an exemplary embodiment, the invention may be used by a fisherman in any setting to secure his fishing rod to a secondary object 200. The fisherman may approach the secondary object 200, place the holder 100 adjacent to the secondary object 200, manipulate the fastener straps 140 in a manner that secures the holder 100 to the secondary object 200, then fix the fastener straps 140 in the appropriate manner. The holder 100 is now set for holding the fishing rod.

In a further exemplary embodiment, the holder 100 may be coupled to a portable anchor brought by the fisherman. Some environments do not have readably available secondary objects. An example of such an environment would be a beach near the water. A fisherman could bring a portable anchor, insert that anchor in the ground, and secure the holder 100 to the anchor. The anchor acts as the previously described secondary object, allowing use of the holder 100.

Therefore, the foregoing is considered illustrative only of the principles of the invention. Further, since numerous modifications and changes will readily occur to those skilled in the art, it is not desired to limit the holder 100 to the exact construction and operation shown and described, and accordingly, all suitable modifications and equivalents may be resorted to, falling within the scope of the holder 100.

1. A holder for securing a fishing rod to a secondary object, comprising:
a receptacle dimensioned to receive said fishing rod; and
a fastening mechanism coupled to said receptacle;
wherein said fastening mechanism comprises:
at least one male section; and
at least one female section;
wherein said at least one of said at least one male section and said at least one female section encircles said secondary object; and
wherein said at least one male section couples to said at least one female section.

2. The holder from claim 1, wherein said receptacle becomes immobile relative to said secondary object.

3. The holder from claim 1, wherein said receptacle is substantially cylindrical.

4. The holder from claim 1, wherein said fastening mechanism comprises at least one of the following:
hook and loop fastener;
snap fastener;
button fastener;
adhesive fastener; or
buckle fastener.

5. The holder from claim 1, wherein said receptacle is secured flush against said secondary object.

6. The holder from claim 1, wherein said receptacle is secured at an angle against said secondary object.

7. The holder from claim 1, wherein said receptacle may extend longitudinally.

8. The holder from claim 1, wherein said receptacle may contract longitudinally.

9. The holder from claim 1, wherein said receptacle further comprises an indentation that accommodates the portion of a reel from said fishing rod.

10. The holder from claim 1, wherein said fastening mechanism comprises:
at least one fastener strap;
wherein said at least one fastener strap comprises at least one male section;
wherein said at least one fastener strap comprises at least one female section; and
wherein said at least one male section couples to said at least one female section.

11. The holder from claim 11,
wherein said receptacle comprises two or more slits; and
wherein said at least one fastener strap is threaded into a first of said two or more slits
and threaded out a second of said two or more slits.

12. The holder from claim 1, further comprising a locking mechanism to prevent removal of said fishing rod from said receptacle.

13. The holder from claim 1, wherein said fastening mechanism is capable of coupling to a horizontal structure.

14. The holder from claim 1, wherein said fastening mechanism is capable of coupling to a vertical structure.

15. The holder from claim 1, wherein said fastening mechanism is capable of coupling to a structure with horizontal and vertical elements.

16. The holder from claim 1, further comprising:
a portable anchor,
wherein said fastening mechanism is capable of coupling to said portable anchor.

17. A system for fishing, comprising:
a fishing pole;
a secondary object; and
a holder capable of securing said fishing pole to said secondary object, comprising:
a receptacle dimensioned to receive said fishing rod; and
a fastening mechanism coupled to said receptacle;
wherein said fastening mechanism comprises at least one male section and at least one female section;
wherein at least one of said at least one male section and said at least one female section encircles said secondary object; and
wherein said at least one male section couples to said at least one female section.

18. A method for fishing, comprising:
placing a holder against a secondary object, wherein said holder comprises:
a receptacle;
at least one male fastener; and
at least one female fastener;
orienting said at least one male fastener and said at least one female fastener in a manner that encircles said secondary object;
tightening at least one of said at least one male fastener and said at least one female fastener to secure said holder with respect to said secondary object;
coupling said at least one male fastener to said at least one female fastener; and
inserting a fishing rod in said receptacle.
